(19) United States
(12) Patent Application Publication
(10) Pub. No.: US 2023/0009828 A1
(43) Pub. Date: Jan. 12, 2023

(54) BODY FOR ELECTRIC TWO-WHEELED VEHICLE

(71) Applicant: MOHENIC MOTORS CO., LTD., Yeongam-gun (KR)

(72) Inventor: Tae-Sung KIM, Goyang-si (KR)

(73) Assignee: MOHENIC MOTORS CO., LTD., Yeongam-gun (KR)

(21) Appl. No.: 17/555,356

(22) Filed: Dec. 17, 2021

(30) Foreign Application Priority Data
Jul. 12, 2021 (KR) 10-2021-0091181

(51) Int. Cl. B62K 11/02; B32B 3/10; B32B 21/02; B32B 15/10

(52) U.S. Cl. CPC B62K 11/02; B32B 3/10; B32B 21/02; B32B 15/10; B32B 2605/00

(57) ABSTRACT

A body for an electric two-wheeled vehicle is proposed. More particularly, proposed is a body for an electric two-wheeled vehicle in which materials of different types are stacked to be light in the weight of the vehicle body, and space receiving a battery is defined to protect the battery and facilitate installation thereof. The body for an electric two-wheeled vehicle includes a frame part having a space part formed in a center part thereof, wherein in the frame part, first and second material layers of different types are alternately stacked to be coupled to each other such that the first and second material layers form multiple layers.

### FIELD OF THE INVENTION

The present disclosure relates generally to a body for an electric two-wheeled vehicle. More particularly, the present disclosure relates to a body for an electric two-wheeled vehicle in which materials of different types are stacked to be light in the weight of the vehicle body, and space receiving a battery is defined to protect the battery and facilitate installation thereof.

### DESCRIPTION OF THE RELATED ART

Generally, a two-wheeled vehicle such as a motorcycle has an engine mounted in a body thereof powered by gasoline or diesel and is run by the power of the engine. Recently, as maintenance costs have increased due to an increase in oil prices and environmental pollution problems have emerged due to the use of fossil fuels such as gasoline and diesel, automobiles and motorcycles using electricity as a next-generation clean energy are being actively developed.

However, in a conventional electric motorcycle that has already been developed, a large-capacity motor instead of an engine is installed in an existing motorcycle structure to drive a motor by using the power of a storage battery, and the driving force of the motor is transmitted to the chain sprocket of a transmission and to the chain sprocket of a driving wheel (a rear wheel) connected to a chain so as to rotate the driving wheel such that the electric motorcycle is driven. Accordingly, the conventional electric motorcycle is required to bear the weight of the body of the conventional electric motorcycle which is the framework thereof, the weight of the transmission, and the weight of the motor having a rather complicated structure installed for power generation, so the entire weight of the electric motorcycle greatly is increased.

Due to the weight increase of the conventional electric motorcycle, the electric motorcycle consumes excessively much power of a motor when driven by using the power of a storage battery to drive the motor, is reduced in output, and has the decreased operating time of the storage battery that supplies power to the motor. Accordingly, the electric motorcycle operating after charging the storage battery is significantly reduced in operating time, so the weight reduction of the electric motorcycle is required to improve fuel efficiency.

In addition, the structure of the electric motorcycle is required to be improved such that the storage battery can be embedded in the body of the electric motorcycle.

Furthermore, since the body of the electric motorcycle is mainly made by welding, a manufacturing process thereof is complicated and skilled manpower is required, so there are problems in that manufacturing time of the electric motorcycle is long and the manufacturing cost thereof is high.

### Documents of Related Art

(Patent Document 1) Korean Patent No. 10-0997614

(Patent Document 2) Korean Patent Application Publication No. 10-2014-0016952

### SUMMARY OF THE INVENTION

Accordingly, the present disclosure has been made keeping in mind the above problems occurring in the related art, and the present disclosure is intended to propose a body for an electric two-wheeled vehicle in which materials of different types are stacked to be light in the weight of the vehicle body, and space receiving a battery is defined to protect the battery and facilitate installation thereof.

In addition, the present disclosure is intended to propose a body for an electric two-wheeled vehicle which is configured by stacking and coupling materials of different types to each other produced to have the same shapes such that the manufacturing time of the vehicle body is decreased and anyone can easily manufacture the vehicle body due to easy manufacturing thereof so as to reduce manufacturing cost thereof.

In order to achieve the above objectives, according to one aspect of the present disclosure, there is provided a body for an electric two-wheeled vehicle, the body including: a frame part having a space part formed in a center part thereof, wherein in the frame part, first and second material layers of different types are alternately stacked to be coupled to each other such that the first and second material layers form multiple layers.

In this case, the first material layer may be made of one of metal and carbon.

In addition, the second material layer may be made of one of wood and synthetic resin.

Furthermore, a seating jaw may be formed on an outer peripheral surface of the space part.

Additionally, in the second material layers, a reinforcement member may be formed in each of a pair of second material layers so as to partition the space part.

In addition, the first material layer may be made of a mixture of metal and carbon.

Furthermore, the second material layer may be made of a mixture of wood and synthetic resin.

According to the body for an electric two-wheeled vehicle of the present disclosure, materials of different types are stacked to be light in the weight of the vehicle body, and space receiving a battery is defined to protect the battery and facilitate installation thereof

In addition, according to the present disclosure, the body for an electric two-wheeled vehicle is configured by stacking and coupling materials of different types to each other produced to have the same shapes, thereby decreasing the manufacturing time of the vehicle body and enabling the vehicle body to be easily manufactured by anyone due to easy manufacturing thereof so as to reduce manufacturing cost thereof.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view illustrating a body for an electric two-wheeled vehicle according to an embodiment of the present disclosure;

FIG. 2 is an exploded perspective view illustrating the body for an electric two-wheeled vehicle according to the present disclosure;

FIG. 3 is a view illustrating a state in which a cover is coupled to the body for an electric two-wheeled vehicle according to the present disclosure;

FIG. 4 is a perspective view illustrating the body for an electric two-wheeled vehicle according to another embodiment of the present disclosure; and

FIG. 5 is an exploded perspective view illustrating the another embodiment of the body for an electric two-wheeled vehicle according to the present disclosure.

### DETAILED DESCRIPTION OF THE INVENTION

Hereinafter, the exemplary embodiments of the present disclosure will be described in more detail with reference to the accompanying drawings. The same reference numerals are used for the same components in the drawings, and duplicate descriptions of the same components are omitted. Additionally, it should be understood that a body for an electric two-wheeled vehicle of the present disclosure may be embodied in many different forms and is not limited to the described embodiments.

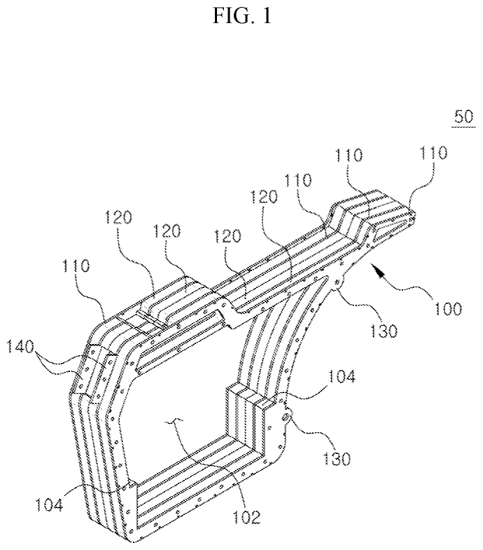

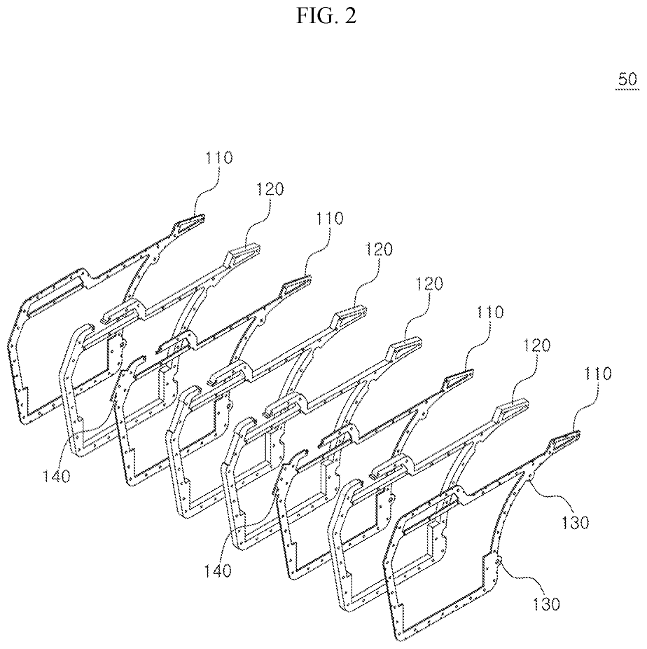

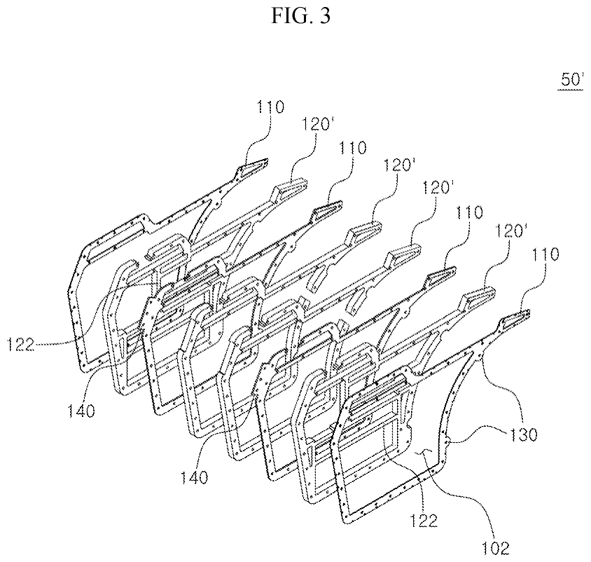

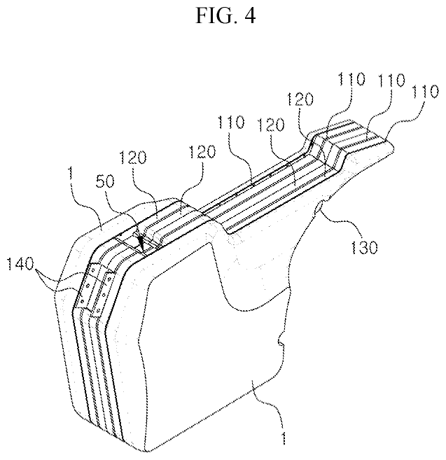

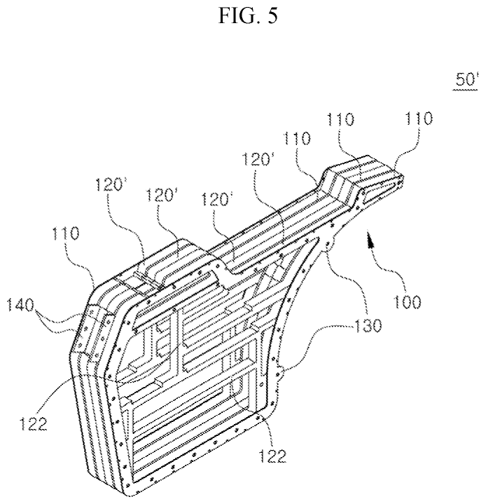

In this case, FIG. 1 is a perspective view illustrating the body for an electric two-wheeled vehicle according to an embodiment of the present disclosure; FIG. 2 is an exploded perspective view illustrating the body for an electric two-wheeled vehicle according to the present disclosure; FIG. 3 is a view illustrating a state in which a cover is coupled to the body for an electric two-wheeled vehicle according to the present disclosure; FIG. 4 is a perspective view illustrating the body for an electric two-wheeled vehicle according to another embodiment of the present disclosure; and FIG. 5 is an exploded perspective view illustrating the another embodiment of the body for an electric two-wheeled vehicle according to the present disclosure.

The present disclosure relates to the body 50 for an electric two-wheeled vehicle. More particularly, the present disclosure relates to the body for an electric two-wheeled vehicle in which materials of different types are stacked to be light in the weight of the vehicle body, and space receiving a battery is defined to protect the battery and facilitate installation thereof. As illustrated in FIGS. 1 and 2, the body for an electric two-wheeled vehicle includes a frame part 100 having a space part 102 formed in a center part thereof such that parts such as batteries and electrical parts are installed in the space part 102, wherein in the frame part 100, first and second material layers 110 and 120 of different types are alternately stacked to be coupled to each other by mechanical means such as bolts, rivets, and pins (not shown) such that the first and second material layers 110 and 120 form multiple layers.

More specifically, the first material layer 110 is located at each of the outermost sides of the frame part 100. The first material layer 110 and the second material layer 120 are alternately stacked, wherein the first material layer 110 is preferably made of a rigid metal or carbon material.

In this case, all of the first material layers 110 may be made of metal or carbon materials. Of course, the first material layers 110 made of metal materials and the first material layers 110 made of carbon materials may be mixed with each other. Accordingly, the first material layer 110 may be variously embodied.

In addition, the second material layer 120 and the first material layer 110 may be alternately stacked, or the second material layers 120 may be stacked next to each other. The second material layer 120 is preferably made of wood or synthetic resin which is lighter in weight than the first material layer 110.

In this case, all of the second material layers 120 may be made of wood or may be made of synthetic resin. Of course, the second material layers 120 made of wood and the second material layers 120 made of synthetic resin may be mixed with each other. Accordingly, the second material layer 120 may be variously embodied.

However, the first material layer 110 and the second material layer 120 are preferably configured such that the stacked structures of the first material layers 110 and the second material layers 120 are symmetrical to each other from the outermost sides of the frame part 100 to the center part thereof.

As described above, the body 50 for an electric two-wheeled vehicle, which is light in weight and excellent in rigidity, can be manufactured by mixing materials of different types having different rigidity and effects with each other to form a stacked structure.

Here, the first material layer 110 and the second material layer 120 are precisely processed by CNC or laser to have predetermined shapes such that the outer peripheral surface of the space part 102 has a predetermined shape.

That is, the outer peripheral surface of the space part 102 is configured to form a straight line in the thickness direction of the frame part 100, and a seating jaw 104 is formed on a side of the outer peripheral surface of the space part 102 such that a part such as a battery can be easily embedded and installed thereon.

Accordingly, a bolt hole is formed at each of the same positions of the first material layer 110 and the second material layer 120, and in a state in which the first material layer 110 and the second material layer 120 are alternately stacked, the first and second layers are fastened to be in close contact with each other by a bolt (not shown) passing through each of the layers in the thickness direction of the frame part 100 from the first material layer 110 of the outermost side of the first side of the frame part to the first material layer 110 of the outermost side of the second side thereof such that the frame part 100 is assembled.

Accordingly, a separate jig is not required, so the assembly of the frame part is easy.

Furthermore, in a state in which the first material layer 110 and the second material layer 120 are alternately stacked, the assembly of the first material layer 110 and the second material layer 120 is completed by bolts (not shown) without welding, so the frame part doesn't have a deformed part because a welding line is not formed thereon.

Additionally, as illustrated in FIG. 3, the assembly of the body 50 for an electric two-wheeled vehicle is completed by coupling a cover 1 to the outer part of the body 50 for an electric two-wheeled vehicle configured as described above 50.

In addition, a first bracket 130 for installing a rear wheel (not shown) may be formed at the rear of the first material layer 110, and a second bracket 140 may be mounted to first material layers 110 located at predetermined layers symmetrical to each other in the first material layers 110 such that the steering wheel axle of a front wheel (not shown) can be mounted thereto. Accordingly, the installation of each component can be easily performed.

In this case, the first bracket 130 and the second bracket 140 may be formed on the first material layer 110 or may be separately manufactured to be coupled thereto by a coupling means such as welding.

Meanwhile, according to the body 50′ for an electric two-wheeled vehicle of another embodiment of the present disclosure, as illustrated in FIGS. 4 and 5, a reinforcement member 122 may be formed in each of at least a pair of second material layers 120′ so as to partition the space part 102.

Here, the remaining configuration of the body 50′ for an electric two-wheeled vehicle configured as described above is the same as the configuration of the body 50 for an electric two-wheeled vehicle according to the above-described embodiment, so a detailed description thereof will be omitted.

However, each of the second material layers 120′ located at predetermined layers symmetrical to each other among the second material layers 120′ has the reinforcement member 122, which partitions the space part 102, formed at a position corresponding to the space part 102 such that the rigidity of the frame part 100 can be reinforced.

In addition, a part such as a battery may be installed in each space partitioned by the reinforcement members 122, thereby making the installation of the part simpler and more secure to protect the part.

Accordingly, according to the body 50 or 50′ for an electric two-wheeled vehicle of the present disclosure as described above, materials of different types are stacked to be light in the weight of the vehicle body, and space receiving a battery is defined to protect the battery and facilitate installation thereof. In addition, the body for an electric two-wheeled vehicle is configured by stacking and coupling materials of different types to each other produced to have the same shapes, thereby decreasing the manufacturing time of the vehicle body and enabling the vehicle body to be easily manufactured by anyone due to easy manufacturing thereof so as to reduce manufacturing cost thereof.

Although the exemplary embodiments of the present disclosure have been described above, the scope of the present disclosure is not limited thereto, but extends to a scope substantially equivalent to the embodiments of the present disclosure. Various modifications may be made by those skilled in the art to which the present disclosure pertains without departing from the spirit of the present disclosure.

### INDUSTRIAL APPLICABILITY

The present disclosure relates to the body for an electric two-wheeled vehicle. More particularly, the present disclosure relates to the body for an electric two-wheeled vehicle in which materials of different types are stacked to be light in the weight of the vehicle body, and space receiving a battery is defined to protect the battery and facilitate installation thereof.

What is claimed is:

1. A body for an electric two-wheeled vehicle, the body comprising:
a frame part having a space part formed in a center part thereof,
wherein in the frame part, first and second material layers of different types are alternately stacked to be coupled to each other such that the first and second material layers form multiple layers.

2. The body of claim 1, wherein the first material layer is made of one of metal and carbon.

3. The body of claim 1, wherein the second material layer is made of one of wood and synthetic resin.

4. The body of claim 1, wherein a seating jaw is formed on an outer peripheral surface of the space part.

5. The body of claim 1, wherein in the second material layers, a reinforcement member is formed in each of a pair of second material layers so as to partition the space part.

6. The body of claim 1, wherein the first material layer is made of a mixture of metal and carbon.

7. The body of claim 1, wherein the second material layer is made of a mixture of wood and synthetic resin.
